(19) United States
(12) Patent Application Publication
(10) Pub. No.: US 2009/0125848 A1
(43) Pub. Date: May 14, 2009

(54) TOUCH SURFACE-SENSITIVE EDIT SYSTEM

(76) Inventors: Susann Marie Keohane, Austin, TX (US); Gerald Francis McBrearty, Austin, TX (US); Shawn Patrick Mullen, Buda, TX (US); Jessica Carol Murillo, Round Rock, TX (US); Johnny Meng-Han Shieh, Austin, TX (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 11/940,059

(22) Filed: Nov. 14, 2007

(51) Int. Cl. G06F 3/033

(52) U.S. Cl. 715/863

(57) ABSTRACT

A method, medium and implementing processing system are provided in which displayed text is manipulated using two fingers within an editing application to select a region of text or objects. In an example, two fingers are placed on a touch-sensitive display or touch pad and the region of text between the fingers is selected. The selected text can be manipulated as otherwise selected text is currently manipulated, e.g. cut, paste and copy functions can be performed. The movement of the fingers also performs this manipulation. In one example, if the fingers are brought to together, the selected text is cut, or a split screen could occur. If the fingers are placed together and then parted, the action would be to part the text to make room for a picture or other insert.

### FIELD OF THE INVENTION

The present invention relates generally to information processing systems and more particularly to a methodology and implementation for utilizing touch-sensitive surface technology in word processing systems.

### BACKGROUND OF THE INVENTION

Currently available laptop computers and smaller electronic devices such as hand-held PCs, organizers and even cell phone devices, all have some capability to run word processor applications. Such applications are used, for example, in creating and editing documents which may be electronically transmitted to other electronic devices directly from the device upon which they were created. However, many of the word processor applications are difficult to use on smaller devices and other applications are lacking in functionality because the size of the device.

Many phone and computer devices have either touch sensitive screens or touch sensitive pads with which a user is enabled to perform certain limited functions. Such operations, however, are difficult for users to execute. For example, when using a touch pad for blocking out text for further word processing functions, a user has had to double-touch the touch pad with the user's finger at a text location marking a beginning of a text section and, without losing contact with the touchpad, drag the finger to the end of the text section desired to comprise a blocked-out portion of text. This operation is relatively difficult for a user to execute. Moreover, changing the blocked-out portion after one has been established is even more difficult and most of the time requires that the initial block be un-done and the entire blocking procedure be re-executed.

Thus there is a need for an improved methodology and implementing system which enables a user to more easily define and manipulate word processing functions using a touch sensitive pad or display screen.

### SUMMARY OF THE INVENTION

A method, medium and implementing processing system are provided in which displayed text is manipulated using two fingers within an editing application to select a region of text or objects. In an example, two fingers are placed on a touch-sensitive display or touch pad and the region of text between the fingers is selected. The selected text can be manipulated as otherwise selected text is currently manipulated, e.g. cut, paste and copy functions can be performed. The movement of the fingers also performs this manipulation. In one example, if the fingers are brought to together, the selected text is cut, or a split screen could occur. If the fingers are placed together and then parted, the action would be to part the text to make room for a picture or other insert.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of a laptop computer embodiment in which the present invention may be implemented;

FIG. 2 is a block diagram showing several of the major components of the laptop computer of FIG. 1;

FIGS. 3A and 3B are illustrations showing text manipulation and corresponding touch pad finger movements to cause the text manipulation;

FIGS. 4A and 4B are illustrations showing text manipulation and corresponding touch pad finger movements to cause the text manipulation;

FIGS. 5A and 5B are illustrations showing text manipulation and corresponding touch pad finger movements to cause the text manipulation;

FIGS. 6A and 6B are illustrations showing text manipulation and corresponding touch pad finger movements to cause the text manipulation;

FIGS. 7A and 7B are illustrations showing text manipulation and corresponding touch pad finger movements to cause the text manipulation; and

FIG. 8 is a flow chart illustrating an operational sequence of an exemplary embodiment of the present invention.

### DETAILED DESCRIPTION

The various methods discussed herein may be implemented within a computing system which includes processing means, memory, storage, input means and display means. Since the individual components of a communication system which may be used to implement the functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention. Although the invention is illustrated in the context of a laptop computer system, it is understood that the principles of the invention may be implemented in any of many available and future communication devices and systems, including but not limited to touch sensitive displays or touch sensitive pads of personal assistant devices, hand-held personal computer devices and cell phone and other wireless communication devices.

Utilizing the methodology of the present invention, selected text can be manipulated in manners otherwise available in word processing programs. Predetermined text and/or image manipulations are performed using two fingers or other pointing objects such as stencils upon a touch sensitive display screen or touch sensitive pad of, for example, a laptop or hand-held computer device. In an example, if the fingers are brought together, the selected or blocked-out text is cut, or a split screen is created. If the fingers are placed together and then parted, the corresponding text action is to part the text to create space for an insert. After the first finger is placed on the touch pad, the second finger can be placed, re-placed or slid to the correct placement to properly identify and/or change the selected or blocked text. Inadvertent cutting and inserting is avoided since the cutting and parting functions are executed only when both fingers are moved in unison.

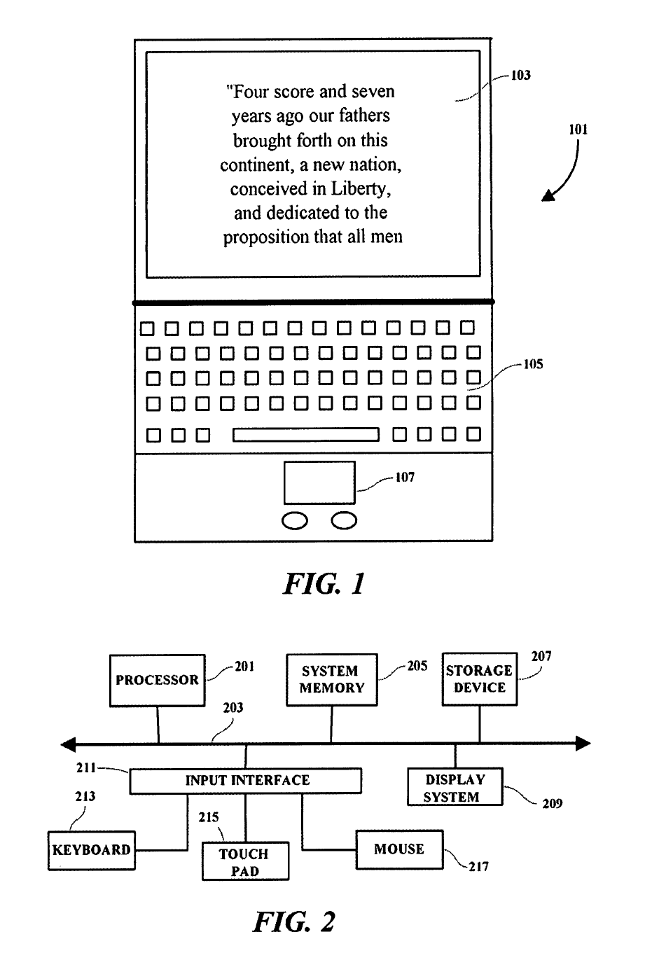

With specific reference to the drawings, in FIG. 1 there is shown a laptop personal computer or PC 101 which includes a display screen 103, a keyboard area 105 and a touch pad 107. The touch pad is arranged to work in a normal manner as an alternative to a mouse device (not shown) to enable a user to provide inputs to accomplish predetermined functions in accordance with whatever application is running on the PC.

In FIG. 2, several of the main components of the PC 101 are illustrated. As shown, the PC includes a processor unit 201 which is connected to a main bus 203. Also connected to the main bus 203 is a system memory 205, a storage unit 207, a display system 209 and a user input interface 211 which, in turn, is configured to receive inputs from a keyboard 213, a mouse 217 and a touch sensitive pad 215.

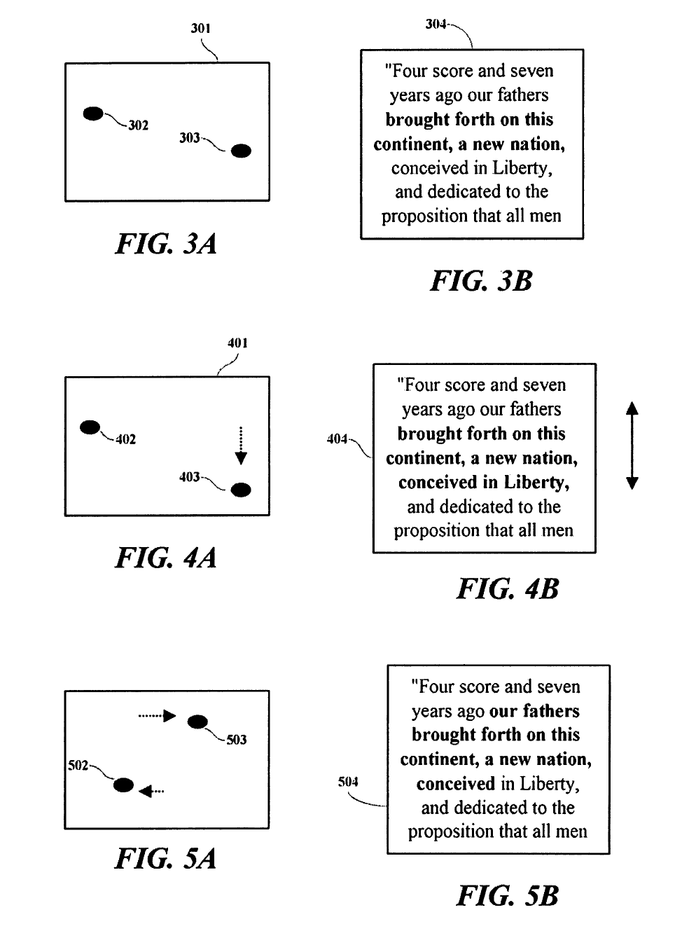

FIGS. 3A and 3B show a touch pad 301 and a corresponding screen display 304, respectively. The touch pad 301 shows points of contact 302 and 303 where a user has placed his or her fingers on the touch pad 301. As shown on the display 304, a portion of the text has been highlighted or emboldened to indicate the portion of the text that has been selected by the placement of the fingers on the touch pad 301. Once the selected text has been blocked out, the block or highlighted text can be cut or deleted, or cut and pasted or copied and pasted or moved as part of a word processing application. The processing disclosed herein establishes a new and more easily practiced method for enabling a user to select text or document sections for further word processing manipulation.

FIGS. 4A and 4B show a touch pad 401 and a corresponding screen display 404, respectively. The touch pad 401 shows points of contact 402 and 403 where a user has placed his or her fingers on the touch pad 401. As shown on the display 404, a portion of the text has been highlighted or emboldened to indicate the portion of the text that has been selected by the placement of the fingers on the touch pad 401. In FIG. 4A, one of the fingers corresponding to touch point 403 has been moved downwardly while the other touch point 402 has remained at the same point as shown in FIG. 3A. This action results in the expansion of the blocked text downwardly for one additional line to now include the text “conceived in Liberty,”. In this manner, by moving only one finger while maintaining the other finger in place, a selected block can be easily expanded or contracted to suit the user's needs.

FIGS. 5A and 5B show a touch pad 501 and a corresponding screen display 504, respectively. The touch pad 501 shows points of contact 502 and 503 which represent points of contact with the touch pad 501. As shown, point 502 was established by moving point 402 to the right from the position shown in FIG. 4A and point 503 was established by moving point 403 to the left from the position shown in FIG. 4A. It is important to note that, in this example, the finger movements to the positions 502 and 503 are accomplished sequentially and not in unison, i.e. the fingers are moved one at a time to the positions shown in FIG. 5A. This action results in changing the blocked text to now include the text “our fathers brought forth on this continent, a new nation, conceived”. Again, these finger movements are done sequentially and not in unison. In this manner, by moving only one finger while maintaining the other finger in place, a selected block can be easily expanded or contracted to suit the user's needs.

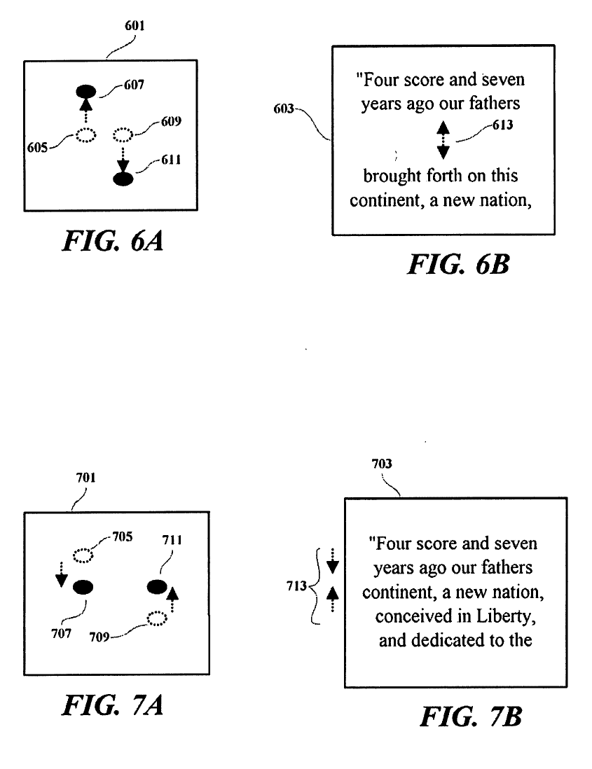

To create spaces in text for the insertion of additional text or graphic images, the process illustrated in FIGS. 6A and 6B may be used. FIG. 6A shows a touch pad 601 including points 607 and 611 and FIG. 6B shows a screen display 603 including a text portion of a document. In FIG. 6A, when the fingers are parted in unison, i.e. when a finger is moved from an initial position 605 to position 607 in unison with a movement of a second finger from 609 to 611, that concurrent movement or parting of the fingers causes the text shown in FIG. 6B to part 613 thereby creating a space in the text which may be used for the insertion of additional text or graphic images.

To merge text together, the process illustrated in FIGS. 7A and 7B may be used. FIG. 7A shows a touch pad 701 including points 707 and 711 and FIG. 7B shows a screen display 703 including a text portion of a document. In FIG. 7A, when the fingers are merged toward each other in unison, i.e. when a finger is moved from an initial position 705 to position 707 in unison with a movement of a second finger from 709 to 711, that concurrent movement or closing of the fingers causes the text shown in FIG. 7B to merge 713 thereby effectively deleting text from the document.

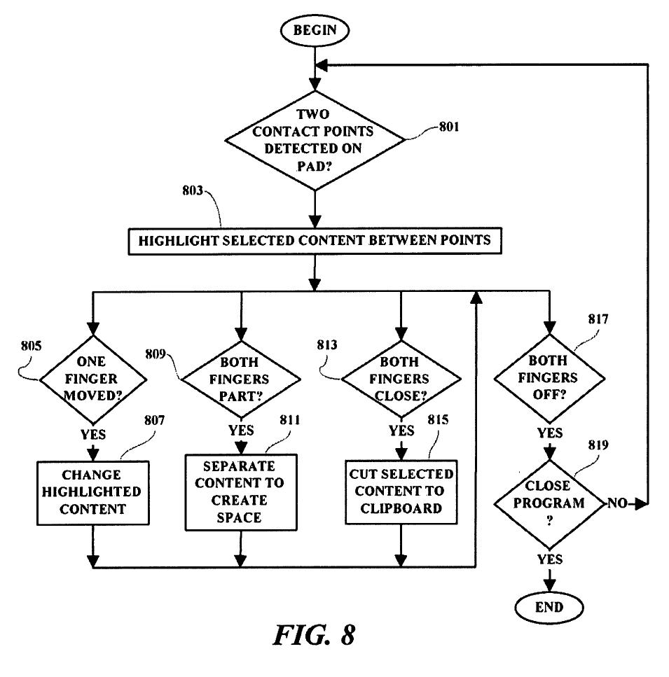

As shown in FIG. 8, in an exemplary operation of a system implementing the present invention, when it is detected that two points of contact have been established 801 on a touch pad, the text between those two point is highlighted or emboldened as selected text for manipulation. Thereafter, one of four actions may occur depending upon the action of the user. If the user removes both fingers from the pad 817, the selected text remains highlighted for subsequent manipulation until two new points are detected 801 or the program is closed 819. If the user moves only one finger 805, the extent of the blocked or selected text is changed accordingly 807 and the process returns to monitor the next user action. If the user parts both fingers in unison 809, the text content is parted to create space in the document 811 and the process again returns to monitor the next action of the user. If the user closes fingers or moves both fingers in unison toward each other 813, corresponding text content is cut 815 and moved to a clipboard for further processing or simply cut from the document. In all cases, when the user removes both fingers from the touch pad 817, the process either closes if the word processor application is closed 819 or returns to await another detection of two contact points on the touch pad 801.

The method and apparatus of the present invention has been described in connection with a preferred embodiment as disclosed herein. The disclosed methodology may be implemented in a wide range of sequences, and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored in any media, including portable or fixed, volatile or non-volatile memory media device, including CDs, RAM and “Flash” memory, or other semiconductor, optical, magnetic or other memory storage media from which it may be loaded and/or transmitted into other media and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for enabling use of a touch sensitive surface of an input device to facilitate performing word processing functions on text content being presented on a display device, said method comprising:
detecting at least two points of contact being simultaneously established with said touch sensitive surface of said input device and providing input signals in response thereto; and
responding to said input signals for enabling word processing functions to be performed on said text content being presented on said display device.

2. The method as set forth in claim 1 wherein said touch sensitive surface comprises a touch pad of a computer device.

3. The method as set forth in claim 2 wherein said computer device is a laptop computer.

4. The method as set forth in claim 1 wherein said touch sensitive surface comprises a touch sensitive display screen of an electronic device.

5. The method as set forth in claim 4 wherein said electronic device is a wireless communication device.

6. The method as set forth in claim 1 wherein said word processing functions include:
selecting a portion of said text content for processing; and
highlighting said selected portion of said text content on said display device.

7. The method as set forth in claim 6 wherein said selecting is initiated by an establishment of two finger contact points on said touch sensitive surface of said input device.

8. The method as set forth in claim 7 wherein said selected portion of said text content is modified by moving a first of said contact points on said touch sensitive surface while maintaining a second of said contact points in an initial position for said second contact point.

9. The method as set forth in claim 8 wherein said moving is accomplished by sliding said first contact point on the surface of said touch sensitive surface.

10. The method as set forth in claim 8 wherein said moving is accomplished by removing and re-establishing said first contact point on said touch sensitive surface while maintaining said second contact point in said initial position for said second contact point.

11. The method as set forth in claim 1 wherein said word processing functions include:
cutting selected text content from said text content being presented on said display device.

12. The method as set forth in claim 1 wherein said word processing functions include dividing said text content into separate portions.

13. The method as set forth in claim 12 wherein said contact points are established by a placement of two fingers on said touch sensitive surface of said input device, said dividing being accomplished by simultaneously separating said fingers on said touch sensitive surface.

14. The method as set forth in claim 1 wherein said word processing functions include deleting a selected portion said text content.

15. The method as set forth in claim 14 wherein said contact points are established by a placement of two fingers on said touch sensitive surface of said input device, said deleting being accomplished by simultaneously moving said fingers together on said touch sensitive surface.

16. A programmed medium for enabling use of a touch sensitive surface of an input device to facilitate performing word processing functions on text content being presented on a display device, said medium being executable by a computing device for:
enabling a detecting at least two points of contact being simultaneously established with said touch sensitive surface of said input device and providing input signals in response thereto; and
enabling responding to said input signals for enabling word processing functions to be performed on said text content being presented on said display device.

17. The medium as set forth in claim 16 wherein said touch sensitive surface comprises a touch pad of said computing device.

18. The method as set forth in claim 17 wherein said computing device is a laptop computer.

19. The method as set forth in claim 16 wherein said touch sensitive surface comprises a touch sensitive display screen of an electronic device.

20. A system for enabling use of a touch sensitive surface of an input device to facilitate performing word processing functions on text content being presented on a display device, said system including:
means for detecting at least two points of contact being simultaneously established with said touch sensitive surface of said input device and providing input signals in response thereto; and
means for responding to said input signals for enabling word processing functions to be performed on said text content being presented on said display device.
